(19) United States
(12) Patent Application Publication
(10) Pub. No.: US 2026/0017251 A1
(43) Pub. Date: Jan. 15, 2026

(54) SYSTEM AND METHOD FOR GENERATING AN AGGREGATED DATASET

(71) Applicant: The Toronto-Dominion Bank, Toronto (CA)

(72) Inventors: Howard Chun CHIN, Toronto (CA); Miroslav STANKOVIC, Boucherville (CA); George GHINDEA, Oakville (CA); Richard Allistair Barklay MACPHERSON, Brampton (CA)

(73) Assignee: The Toronto-Dominion Bank, Toronto (CA)

(21) Appl. No.: 18/770,924

(22) Filed: Jul. 12, 2024

(51) Int. Cl. G06F 16/23; G06F 11/34

(52) U.S. Cl. CPC G06F 16/2386; G06F 11/3409; G06F 16/2393

(57) ABSTRACT

A computer system comprises and a memory storing instructions that, when executed by the at least one processor, cause the at least one processor to ingest data from at least one first external data source in response to a first trigger condition; halt the ingesting of data from the at least one first external data source; ingest data from at least one second external data source in response to a second trigger condition; halt the ingesting of data from the at least one second external data source; and prior to a third trigger condition, aggregate the data ingested from the at least one first external data source and the data ingested from the at least one second external data source to generate an aggregated dataset. The first external data source may include a machine learning module trained to predict when network traffic will likely drop below a first threshold.

### TECHNICAL FIELD

The present application relates to systems and methods for generating an aggregated dataset.

### BACKGROUND

Data ingestion often requires a significant amount of computing resources. For example, ingesting data from one or more external data sources results in an increase in network traffic.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2 is a high-level schematic diagram of an example computer system;

FIG. 3 shows a simplified organization of software components stored in a memory of the example computer system of FIG. 2;

FIG. 4 is a flowchart showing operations performed in generating an aggregated dataset according to an embodiment;

FIG. 5 is a flowchart showing operations performed in determining a first trigger condition according to an embodiment;

FIG. 6 is an example flowchart showing the generation of an aggregated dataset according to an embodiment;

FIG. 7 is a flowchart showing operations performed in retrieving previously ingested data according to an embodiment; and

FIG. 8 is a flowchart showing operations performed in providing a database view to a computing device according to an embodiment.

Like reference numerals are used in the drawings to denote like elements and features.

### DETAILED DESCRIPTION OF VARIOUS EMBODIMENTS

Accordingly, in one aspect there is provided a computer system comprising at least one processor; a communications module, coupled to the at least one processor, for communicating with one or more computer networks; and a memory coupled to the at least one processor and storing instructions that, when executed by the at least one processor, cause the at least one processor to ingest data from at least one first external data source in response to a first trigger condition; halt the ingesting of data from the at least one first external data source; ingest data from at least one second external data source in response to a second trigger condition; halt the ingesting of data from the at least one second external data source; and prior to a third trigger condition, aggregate the data ingested from the at least one first external data source and the data ingested from the at least one second external data source to generate an aggregated dataset.

In one or more embodiments, the first trigger condition includes at least one of determine that a current amount of network traffic drops below a first threshold; determine that a current time is equal to a first predefined trigger time; or determine that data from the at least one first external data source is available.

In one or more embodiments, the second trigger condition includes at least one of determine that the ingesting of the data from the at least one first external data source is complete; determine that a current amount of network traffic drops below a second threshold; determine that a current time is equal to a second predefined trigger time; or determine that data from the at least one second external data source is available.

In one or more embodiments, when aggregating the data ingested from the at least one first external data source and the data ingested from the at least one second external data source to generate the dataset, the instructions, when executed by the at least one processor, further cause the at least one processor to estimate at least one data point of the aggregated dataset based on at least one of the data ingested from the at least one first external data source and the data ingested from the at least one second external data source.

In one or more embodiments, the at least one first external data source is different then the at least one second external data source.

In one or more embodiments, ingesting data from the at least one first external data source including batch processing data received from the at least one first external data source.

In one or more embodiments, ingesting data from the at least one second external data source includes batch processing data received from the at least one second external data source.

In one or more embodiments, the data ingested from the at least one first external data source includes a first dataset that has one or more data points that align with one or more data points of the aggregated dataset.

In one or more embodiments, the one or more data points of the first dataset serve as a starting point for the one or more data points of the aggregated dataset.

In one or more embodiments, when aggregating the data ingested from the at least one first external data source and the data ingested from the at least one second external data source to generate an aggregated dataset, the instructions, when executed by the at least one processor, further cause the at least one processor to update the one or more data points of the first dataset based on data ingested from the at least one second external data source to generate the one or more data points of the aggregated dataset.

According to another aspect there is provided a method comprising ingesting data from at least one first external data source in response to a first trigger condition; halting the ingesting of data from the at least one first external data source; ingesting data from at least one second external data source in response to a second trigger condition; halting the ingesting of data from the at least one second external data source; and prior to a third trigger condition, aggregating the data ingested from the at least one first external data source and the data ingested from the at least one second external data source to generate an aggregated dataset.

In one or more embodiments, the first trigger condition includes at least one of determining that a current amount of network traffic drops below a first threshold; determining that a current time is equal to a first predefined trigger time; or determining that data from the at least one first external data source is available.

In one or more embodiments, the second trigger condition includes at least one of determining that the ingesting of the data from the at least one first external data source is complete; determining that a current amount of network traffic drops below a second threshold; determining that a current time is equal to a second predefined trigger time; or determining that data from the at least one second external data source is available.

In one or more embodiments, aggregating the data ingested from the at least one first external data source and the data ingested from the at least one second external data source to generate the dataset includes estimating at least one data point of the aggregated dataset based on at least one of the data ingested from the at least one first external data source and the data ingested from the at least one second external data source.

In one or more embodiments, the first external data source is different then the second external data source.

In one or more embodiments, ingesting data from the at least one first external data source including batch processing data received from the at least one first external data source.

In one or more embodiments, ingesting data from the at least one second external data source includes batch processing data received from the at least one second external data source.

In one or more embodiments, the data ingested from the at least one first external data source includes a first dataset that has one or more data points that align with one or more data points of the aggregated dataset.

In one or more embodiments, when aggregating the data ingested from the at least one first external data source and the data ingested from the at least one second external data source to generate an aggregated dataset, the method comprises updating the one or more data points of the first dataset based on data ingested from the at least one second external data source to generate the one or more data points of the aggregated dataset.

According to another aspect there is provided a non-transitory computer-readable storage medium storing instructions that, when executed by at least one processor of a computer system, cause the computer system to ingest data from at least one first external data source in response to a first trigger condition; halt the ingesting of data from the at least one first external data source; ingest data from at least one second external data source in response to a second trigger condition; halt the ingesting of data from the at least one second external data source; and prior to a third trigger condition, aggregate the data ingested from the at least one first external data source and the data ingested from the at least one second external data source to generate an aggregated dataset.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, examples involving a general-purpose computer, aspects of the disclosure transform the general-purpose computer into a special-purpose computing device when configured to execute the instructions described herein.

In the present application, various functionalities discussed herein may be performed by a single processor or by any one of one or more processors, either alone or in combination.

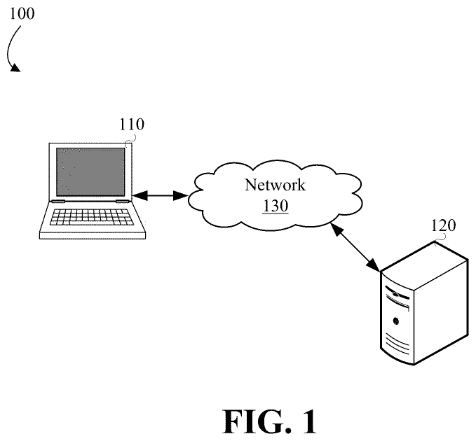

FIG. 1 is a schematic operation diagram illustrating an operating environment of an example embodiment. As shown, the system 100 includes a computing device 110 and a server computer system 120 coupled to one another through a network 130, which may include a public network such as the Internet and/or a private network. The computing device 110 and the server computer system 120 may be in geographically disparate locations. Put differently, the computing device 110 and the server computer system 120 may be located remote from one another.

The server computer system 120 is a computer server system. A computer server system may, for example, be a mainframe computer, a minicomputer, or the like. In some implementations thereof, a computer server system may be formed of or may include one or more computing devices. A computer server system may include and/or may communicate with multiple computing devices such as, for example, database servers, computer servers, and the like. Multiple computing devices such as these may be in communication using a computer network and may communicate to act in cooperation as a computer server system. For example, such computing devices may communicate using a local-area network (LAN). In some embodiments, a computer server system may include multiple computing devices organized in a tiered arrangement. For example, a computer server system may include middle tier and back-end computing devices. In some embodiments, a computer server system may be a cluster formed of a plurality of interoperating computing devices.

The computing device 110 may be a laptop computer as shown in FIG. 1. However, the computing device 110 may be a computing device of another type such as for example a personal computer, a tablet computer, a notebook computer, a hand-held computer, a personal digital assistant, a portable navigation device, a mobile phone, a wearable computing device (e.g., a smart watch, a wearable activity monitor, wearable smart jewelry, and glasses and other optical devices that include optical head-mounted displays), an embedded computing device (e.g., in communication with a smart textile or electronic fabric), and any other type of computing device that may be configured to store data and software instructions, and execute software instructions to perform operations consistent with disclosed embodiments.

The network 130 is a computer network. In some embodiments, the network 130 may be an internetwork such as may be formed of one or more interconnected computer networks. For example, the network 130 may be or may include an Ethernet network, an asynchronous transfer mode (ATM) network, a wireless network, a telecommunications network, or the like.

Although not shown in FIG. 1, the system 100 may include one or more external data sources that may be configured to provide data to the server computer system 120. The one or more external data sources may include one or more third party servers. The server computer system 120 may communicate with the one or more external data sources via the network 130 directly or by way of one or more application programming interfaces (APIs). In this manner, the server computer system 120 ingests data from the one or more external data sources.

The server computer system 120 may maintain a database that may store the data ingested from the one or more external data sources.

Although not shown, the system 100 may include one or more network analyzers that may be configured to collect, monitor and report traffic data relating to network traffic that passes through the network 130. In one or more embodiments, a network analyzer may be dedicated to monitor network traffic between the server computer system 120 and a particular external data source. For example, a first network analyzer may collect, monitor and report traffic data relating to network traffic between the server computer system 120 and a first external data source. Similarly, a second network analyzer may collect, monitor and report traffic data relating to network traffic between the server computer system 120 and a second external data source. As will be described in more detail below, the traffic data may be used to selectively ingest data from the one or more external data sources.

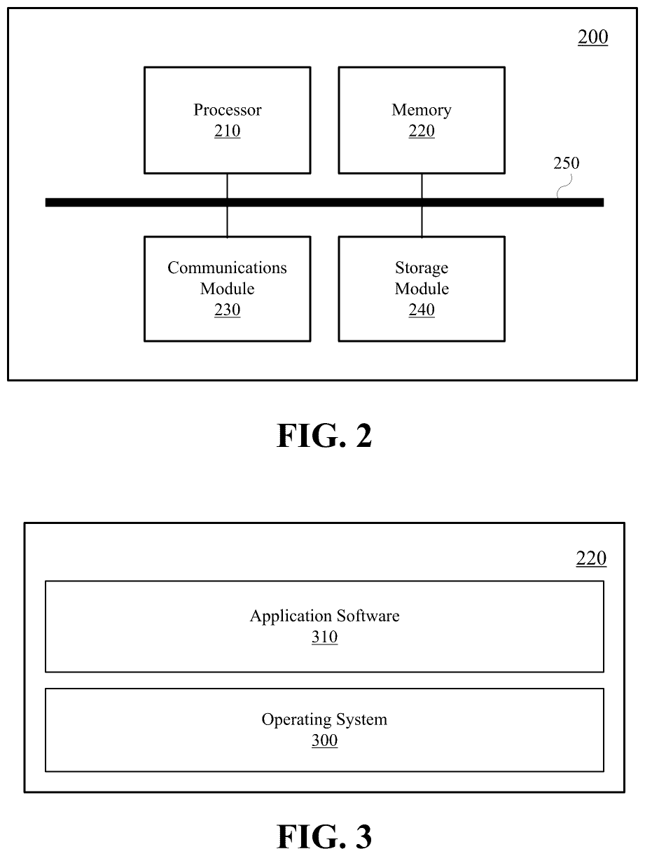

FIG. 2 is a high-level schematic diagram of a computer system 200. The computer system 200 may be any one of the computing device 110 and/or the server computer system 120.

The computer system 200 includes a variety of modules. For example, as illustrated, the computer system 200 may include a processor 210, a memory 220, a communications module 230, and/or a storage module 240. Further, while not illustrated in FIG. 2, the computer system 200 may include an I/O module. As illustrated, the foregoing example modules of the computer system 200 are in communication over a bus 250. As such, the bus 250 may be considered to couple the various modules of the computer system 200 to each other, including, for example, to the processor 210.

The processor 210 is a hardware processor. The processor 210 may, for example, be one or more ARM, Intel x86, PowerPC processors or the like.

The memory 220 allows data to be stored and retrieved. The memory 220 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the computer system 200.

The communications module 230 allows the computer system 200 to communicate with other computing devices and/or various communications networks such as, for example, the network 130. For example, the communications module 230 may allow the computer system 200 to send or receive communications signals. Communications signals may be sent or received according to one or more protocols or according to one or more standards. The communications module 230 may allow the computer system 200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 230 may allow the computer system 200 to communicate using near-field communication (NFC), via Wi-Fi™, using Bluetooth™ or via some combination of one or more networks or protocols. In some embodiments, all or a portion of the communications module 230 may be integrated into a component of the computer system 200. For example, the communications module 230 may be integrated into a communications chipset.

The I/O module is an input/output module. The I/O module allows the computer system 200 to receive input from and/or to provide input to components of the computer system 200 such as, for example, various input modules and output modules. For example, the I/O module may, as shown, allow the computer system 200 to receive input from and/or provide output to a display.

The storage module 240 allows data to be stored and retrieved. In some embodiments, the storage module 240 may be formed as a part of the memory 220 and/or may be used to access all or a portion of the memory 220. Additionally or alternatively, the storage module 240 may be used to store and retrieve data from persisted storage other than the persisted storage (if any) accessible via the memory 220. In some embodiments, the storage module 240 may be used to store and retrieve data in/from a database when the computer system is operating as the server computer system 120 of FIG. 1. A database may be stored in persisted storage. Additionally or alternatively, the storage module 240 may access data stored remotely such as, for example, as may be accessed using a local area network (LAN), wide area network (WAN), personal area network (PAN), and/or a storage area network (SAN). In some embodiments, the storage module 240 may access data stored remotely using the communications module 230. In some embodiments, the storage module 240 may be omitted and its function may be performed by the memory 220 and/or by the processor 210 in concert with the communications module 230 such as, for example, if data is stored remotely.

Software comprising instructions is executed by the processor 210 from a computer-readable medium. For example, software may be loaded into random-access memory from persistent storage of the memory 220. Additionally or alternatively, instructions may be executed by the processor 210 directly from read-only memory of the memory 220.

FIG. 3 depicts a simplified organization of software components stored in the memory 220 of the computer system 200. As illustrated, these software components include an operating system 300 and an application 310.

The operating system 300 is software. The operating system 300 allows the application 310 to access the processor 210 (FIG. 2), the memory 220, the communications module 230, the I/O module, and the storage module 240 of the computer system 200. The operating system 300 may be, for example, Google™ Android™, Apple™ iOS™, UNIX™, Linux™, Microsoft™ Windows™, Apple OSX™ or the like.

The application 310 adapts the computer system 200, in combination with the operating system 300, to operate as a device for performing a specific function. For example, the application 310 may cooperate with the operating system 300 to adapt a suitable embodiment of the example computer system 200 to operate as the computing device 110 and/or the server computer system 120.

While a single application 310 is illustrated in FIG. 3, in operation the memory 220 may include more than one application 310 and different applications 310 may perform different operations. For example, in at least some embodiments in which the computer system 200 is functioning as the computing device 110, the applications 310 may include a web browser, which may also be referred to as an Internet browser. In at least some such embodiments, the server computer system 120 may be a web server that may serve one or more of the interfaces described herein. The web server may cooperate with the web browser and may serve as an interface when the interface is requested through the web browser.

By way of further example, in at least some embodiments in which the computer system 200 functions as the server computer system 120, the applications 310 may include an application configured for secure communications with one or more application programming interfaces (APIs). The application may include, for example, a Hypertext Transfer Protocol (HTTP) client. Through the application, the server computer system 120 may be configured to communicate API requests such as for example GET requests to one or more API endpoints.

By way of further example, in at least some embodiments in which the computer system 200 functions as the server computer system 120, the applications 310 may include a database management software tool that may provide a platform for creating, managing, storing and manipulating data within the database maintained by the server computer system 120.

The server computer system 120 may selectively ingest data from one or more external data sources based on one or more trigger conditions and may generate an aggregated dataset using the data ingested from the one or more external data sources.

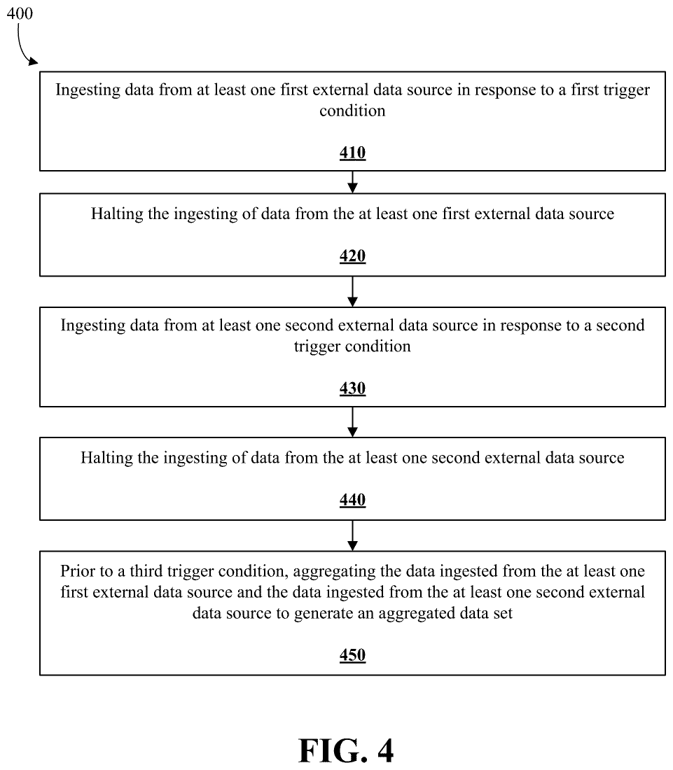

Reference is made to FIG. 4, which illustrates, in flowchart form, a method 400 for generating an aggregated dataset. The method 400 may be implemented by a computing device having suitable processor-executable instructions for causing the computing device to carry out the described operations. The method 400 may be implemented, in whole or in part, by the server computer system 120. At least some of the operations may be performed or otherwise offloaded to one or more of the external data sources, as will be described.

The method 400 includes ingesting data from at least one first external data source in response to a first trigger condition (step 410).

The server computer system 120 ingests data from at least one first external data source in response to a first trigger condition. In one or more embodiments, the data ingested from the at least one first external data source may include a first dataset that has one or more data points.

In one or more embodiments, the first trigger condition may be defined by the server computer system 120 and may be determined by the at least one first external data source. For example, the server computer system 120 may communicate a request for data ingestion to the at least one first external data source. The request may define a type of data to be ingested and may also define a trigger condition for when the server computer system 120 would like to ingest the data. The at least one first external data source may store the request in memory and may perform operations to obtain and communicate the requested data to the server computer system 120 in response to determining the first trigger condition.

In one or more embodiments, the first trigger condition includes at least one of determining that a current amount of network traffic drops below a first threshold, determining that a current time is equal to a first predefined trigger time, and/or determining that the data from the at least one first external data source is available.

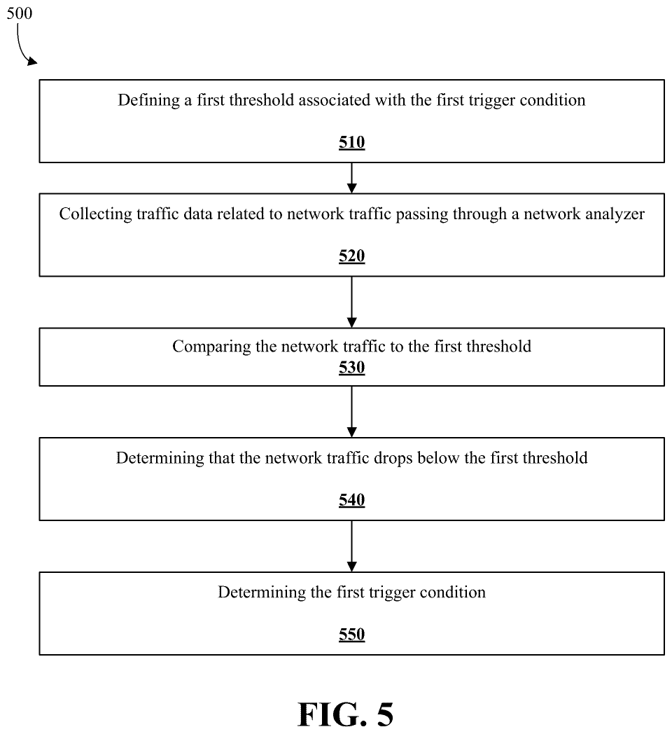

The at least one first external data source may perform operations to determine the first trigger condition. Reference is made to FIG. 5, which illustrates, in flowchart form, a method 500 for determining the first trigger condition in embodiments where the first trigger condition includes determining that a current amount of network traffic drops below a first threshold. The method 500 may be implemented by a computing device having suitable processor-executable instructions for causing the computing device to carry out the described operations. As mentioned, the method 500 may be implemented, in whole or in part, by the at least one first external data source. Of course, at least some of the operations may be performed or otherwise offloaded to the server computer system.

The method 500 includes defining a first threshold associated with the first trigger condition (step 510).

The first threshold may be obtained from the first trigger condition received from the server computer system 120. The first threshold may define a limit of network traffic. For example, network traffic below the first threshold may be deemed acceptable and network traffic above the first threshold may be deemed unacceptable. Unacceptable network traffic may result in an overloaded network and this may impact the overall functionality of the network.

For example, an overloaded network may have degraded performance. Specifically, as network resources become saturated, the performance of network connected services and applications may deteriorate. As a result, this may manifest slower response times, increased latency, and/or buffering or stuttering in data transmission.

As another example, an overloaded network may cause service disruptions. For example, some network connected services may experience partial or complete outages rendering them inaccessible. Service disruptions may occur due to exhausted network bandwidth, overwhelmed servers or failures in network equipment.

As another example, an overloaded network may result in packet loss. For example, under heavy network load, network devices may drop packets due to congestion, leading to packet loss. Packet loss can degrade the quality of real-time communications and disrupt data transmission, requiring retransmissions and affecting overall network efficiency.

As yet another example, an overloaded network may result in increased latency and this may lead to delays in data delivery, longer loading times, and reduced interactivity with online applications.

As still yet another example, an overloaded network may have security vulnerabilities. For example, network overload may create opportunity for security breaches and cyber attacks. Overwhelmed network infrastructure may struggle to enforce security policies, struggle to monitor traffic for malicious activity, or may struggle to respond to security incidents effectively, leaving the network more susceptible to unauthorized access, data breaches, and denial-of-service attacks.

To reduce the likelihood of an overloaded network, the first threshold may define a limit of network traffic that is deemed to be acceptable or safe and this may be dependent on the characteristics of the network. For example, the first threshold may depend on various network factors such as for example network infrastructure, the types of applications and services being utilized, and expectations for performance and reliability.

The first threshold may be received or determined by the at least one first external data source and may be stored in memory.

The method 500 includes collecting traffic data related to network traffic passing through a network analyzer (step 520).

The at least one first external data source may collect traffic data related to network traffic passing through a network analyzer. In one or more embodiments, the network analyzer may be dedicated to monitoring network traffic solely between the server computer system 120 and the at least one first external data source and collecting traffic data related to the same. The network analyzer may include, for example, a network appliance and/or one or more software tools configured to monitor traffic between the server computer system 120 and the at least one first external data source. The traffic data may include, for example, network delay, packet loss, jitter, bandwidth, throughput, network availability, etc.

It will be appreciated that in one or more embodiments the collecting of the traffic data is continuous in that the network analyzer may continuously monitor traffic data related to network traffic passing therethrough.

The method 500 includes comparing the network traffic to the first threshold (step 530).

The network traffic, represented by the traffic data, is compared to the first threshold. For example, the traffic data may include throughput and the first threshold may define a limit as to the maximum amount of throughput deemed to be acceptable.

The method 500 includes determining that the network traffic drops below the first threshold (step 540).

Based on the comparison of the network traffic to the first threshold, it may be determined that the network traffic drops below the first threshold. For example, the throughput may be above the first threshold and the network analyzer may continuously monitor the throughput and may determine that the throughput drops below the first threshold and thus is deemed to be acceptable.

The method 500 includes determining the first trigger condition (step 550).

Responsive to determining that the network traffic drops below the first threshold, the first trigger condition is determined.

It will be appreciated that the at least one first external data source may perform additional or alternative operations to determine the first trigger condition. For example, the first trigger condition may include determining that a current time is equal to a first predefined trigger time. In this example, the at least one first external data source may monitor a current time. When the current time is equal to a first predefined trigger time, the at least one first external data source may determine the first trigger condition.

In embodiments where the first trigger condition includes determining that a current time is equal to a first predefined trigger time, the first predefined trigger time may include or may be related to an end of business day trigger time. As such, when the current time reaches the end of business day trigger time, the at least one first external data source may determine the first trigger condition.

As another example, the first trigger condition may include determining that data from the at least one first external data source is available. For example, the at least one first external data source may collect or otherwise obtain the data requested by server computer system 120 and the trigger condition may be determined when all of the requested data has been obtained.

It will be appreciated that the first trigger condition may include a combination determining that a current amount of network traffic drops below a first threshold, determining that a current time is equal to a first predefined trigger time, and/or determining that the data from the at least one first external data source is available.

As one example, the first trigger condition may include determining that a current time is equal to a first predefined trigger time and determining that the data from the at least one first external data source is available. In this example, the at least one first external data source may determine that the current time is equal to the first predefined trigger time and in response may perform operations to obtain the requested data.

As another example, the at least one first external data source may include a machine learning module that may be trained to predict when it is likely that the network traffic will drop below the first threshold. For example, training data may be collected that tracks all times when the network traffic is below the first threshold and the machine learning module may be trained using the training data. Once trained, the machine learning module may determine a future time that is likely when the network traffic is going to be below the first threshold. The future time may be set as the first predefined trigger time. As such, when the current time is equal to the first predefined trigger time, the first trigger condition may be determined.

In response to the first trigger condition, the at least one first external data source communicates data via the network 130 to the server computer system 120.

Referring back to step 410 of the method 400, the server computer system 120 ingests the data communicated from the at least one first external data source in response to the first trigger condition. The ingesting of data from the at least one first external data source may include batch processing the data received from the at least one first external data source. For example, the data may be ingested such that it is received in batches or chunks. The batches or chunks may be ingested in defined intervals such as for example every minute, hour, day, etc.

The method 400 includes halting the ingesting of data from the at least one first external data source (step 420).

Once data has been ingested from the at least one first external data source, the server computer system 120 and/or the at least one first external data source may halt the ingesting of the data by the server computer system 120. For example, the ingesting of data may include batch processing and as such the at least one first external data source may halt communicating the data to the server computer system 120 and/or the server computer system 120 may halt ingesting any additional data received from the at least one first external data source.

It will be appreciated that the halting may be in response to the first trigger condition not being satisfied. For example, the data may be ingested in response to a determination that network traffic drops below a first threshold. It may be determined that the network traffic has gone back above the first threshold and as such the halting may be initiated.

It will be appreciated that the halting may be in response to a determination that all of the requested data has been received from the at least one first external data source. For example, the server computer system 120 may monitor the data being ingested and may determine that all of the requested data may have been received. As such, the server computer system 120 may halt the ingesting of the data. As another example, the at least one first external data source may determine that all of the requested data has been sent to the server computer system 120 and as such may halt the ingesting of the data by the server computer system 120 by halting communications with the server computer system 120.

The method 400 includes ingesting data from at least one second external data source in response to a second trigger condition (step 430).

In one or more embodiments, the at least one second external data source is different than the at least one first external data source. The server computer system 120 ingests data from at least one second external data source in response to a second trigger condition. In one or more embodiments, the data ingested from the at least one second external data source may include data that may be used to update one or more data points of the first dataset.

In one or more embodiments, the second trigger condition may be defined by the server computer system 120 and may be determined by the at least one second external data source. For example, the server computer system 120 may communicate a request for data ingestion to the at least one second external data source. The request may define a type of data to be ingested and may also define a trigger condition for when the server computer system 120 would like to ingest the data. The at least one second external data source may store the request in memory and may perform operations to obtain and communicate the requested data to the server computer system 120 in response to determining the second trigger condition.

In one or more embodiments, the second trigger condition includes at least one of determining that the ingesting of the data from the at least one first external data source is complete, determining that a current amount of network traffic drops below a second threshold, determining that a current time is equal to a second predefined trigger time, and/or determining that the data from the at least one second external data source is available.

In one or more embodiments, the at least one second external data source may perform operations to determine the second trigger condition. In one example, the server computer system 120 may communicate a signal to the at least one second external data source indicating that the ingesting of the data from the at least one first external data source is complete and in response, the at least one second external data source may determine the second trigger condition and the data ingestion by the server computer system 120 may be initiated.

As another example, the at least one second external data source may perform operations to determine that a current amount of network traffic drops below a second threshold. In this example, the at least one second external data source may perform operations similar to those outlined with reference to method 500 described herein. It will be appreciated however that the second threshold may be different than the first threshold. For example, the second threshold may be obtained from the second trigger condition received from the server computer system 120. The second threshold may define a limit of network traffic. For example, network traffic below the second threshold may be deemed acceptable and network traffic above the second threshold may be deemed unacceptable. Unacceptable network traffic may result in an overloaded network and this may impact the overall functionality of the network as described herein.

To reduce the likelihood of an overloaded network, the second threshold may define a limit of network traffic that is deemed to be acceptable or safe and this may be dependent on the characteristics of the network. For example, the second threshold may depend on various network factors such as for example network infrastructure, the types of applications and services being utilized, and expectations for performance and reliability.

The at least one second external data source may collect traffic data related to network traffic passing through a network analyzer. In one or more embodiments, the network analyzer may be dedicated to monitoring network traffic solely between the server computer system 120 and the at least one second external data source and collecting traffic data related to the same. The network analyzer may include, for example, a network appliance and/or one or more software tools configured to monitor traffic between the server computer system 120 and the at least one second external data source. The traffic data may include, for example, network delay, packet loss, jitter, bandwidth, throughput, network availability, etc.

It will be appreciated that in one or more embodiments the collecting of the traffic data is continuous in that the network analyzer may continuously monitor traffic data related to network traffic passing therethrough.

The traffic data may be used to determine the second trigger condition in manners similar to that described herein with reference to the method 500.

The second threshold may be different than the first threshold. For example, network communications between the at least one second external data source and the server computer system 120 may have different characteristics than network communications between the at least one first external data source and the server computer system 120 and as such the second threshold may be different than the first threshold.

In one or more embodiments, data ingested from the at least one first external data source may be deemed more important than data ingested from the at least one second external data source. As such, the data ingested from the at least one first external data source may be prioritized over the data ingested from the at least one second data source and this may be done using different thresholds. For example, the first trigger condition may include a first threshold that defines a first acceptable amount of network traffic and the second trigger condition may include a second threshold that defines a second acceptable amount of network traffic. The first threshold may be greater than the second threshold and this may be done to prioritize ingesting of data from the at least one first external source over ingesting of data from the at least one second external source.

In one or more embodiments, data ingested from the at least one second external data source may be performed downstream of the data ingested from the at least one first external data source. For example, the data ingested from the at least one second external data source may only be performed after it is determined that the ingesting of the data from the at least one first data source is complete.

It will be appreciated that the at least one second external data source may perform additional or alternative operations to determine the second trigger condition. For example, the second trigger condition may include determining that a current time is equal to a second predefined trigger time. In this example, the at least one second external data source may monitor a current time. When the current time is equal to a second predefined trigger time, the at least one second external data source may determine the second trigger condition.

In embodiments where the second trigger condition includes determining that a current time is equal to a second predefined trigger time, the second predefined trigger time may include or may be related to an end of business day or after hours trigger time. As such, when the current time reaches the end of business day trigger time or the after hours trigger time, the at least one second external data source may determine the second trigger condition.

As another example, the second trigger condition may include determining that data from the at least one second external data source is available. For example, the at least one second external data source may collect or otherwise obtain the data requested by server computer system 120 and the trigger condition may be determined when all of the requested data has been obtained.

It will be appreciated that the second trigger condition may include a combination determining that the ingesting of the data from the at least one first external data source is complete, determining a current amount of network traffic drops below a second threshold, determining that a current time is equal to a second predefined trigger time, and/or determining that the data from the at least one second external data source is available and this may be similar to that described herein with reference to the first trigger condition.

In response to the second trigger condition, the at least one second external data source communicates data via the network 130 to the server computer system 120.

The server computer system 120 ingests the data communicated from the at least one second external data source in response to the second trigger condition. The ingesting of data from the at least one second external data source may include batch processing the data received from the at least one second external data source. For example, the data may be ingested such that it is received in batches or chunks. The batches or chunks may be ingested in defined intervals such as for example every minute, hour, day, etc.

The method 400 includes halting the ingesting of data from the at least one second external data source (step 440).

Once data has been ingested from the at least one second external data source, the server computer system 120 and/or the at least one second external data source may halt the ingesting of the data by the server computer system 120. For example, the ingesting of data may include batch processing and as such the at least one second external data source may halt communicating the data to the server computer system 120 and/or the server computer system 120 may halt ingesting any additional data received from the at least one second external data source.

It will be appreciated that the halting may be in response to the second trigger condition not being satisfied. For example, the data may be ingested in response to a determination that network traffic drops below a second threshold. It may be determined that the network traffic has gone back above the second threshold and as such the halting may be initiated.

It will be appreciated that the halting may be in response to a determination that all of the requested data has been received from the at least one second external data source. For example, the server computer system 120 may monitor the data being ingested and may determine that all of the requested data may have been received. As such, the server computer system 120 may halt the ingesting of the data. As another example, the at least one second external data source may determine that all of the requested data has been sent to the server computer system 120 and as such may halt the ingesting of the data by the server computer system 120 by halting communications with the server computer system 120.

The method 400 includes prior to a third trigger condition, aggregating the data ingested from the at least one first external data source and the data ingested from the at least one second external data source to generate an aggregated dataset (step 450).

Prior to a third trigger condition, the data ingested from the at least one first external data source and the data ingested from the at least one second external data source are aggregated to generate an aggregated dataset.

In one or more embodiments, the third trigger condition may include determining that the ingesting of the data from the at least one first external data source and the at least one second external data source is complete. For example, the server computer system 120 may determine that the ingesting of the data from the at least one first external data source and the at least one second external data source has been completed and that all required data has been received or otherwise obtained.

In one or more embodiments, the third trigger condition may include determining that a current time is equal to a third predefined trigger time. For example, the server computer system 120 may receive or otherwise obtain the third predefined trigger time and may store the third predefined trigger time in memory. The third predefined trigger time may define a time as to when the aggregated dataset must be generated.

The aggregated dataset includes one or more data points. In one or more embodiments, when aggregating the data ingested from the at least one first external data source and the data ingested from the at least one second external data source to generate the dataset, the server computer system 120 may estimate at least one data point of the aggregated dataset based on at least one of data ingested from the at least one first external data source and the data ingested from the at least one external data source.

In one or more embodiments, rules may be defined for each data point of the aggregate dataset. The rule may define one or more data points of the data ingested from the at least one first external data source and/or one or more data points of the data ingested from the at least one second external data source that are to be used to generate one or more of the data points of the aggregated dataset. The rules may additionally define rules and/or equations specifying how the data points are to be combined. For example, computer program may be defined for a particular data point of the aggregated dataset that specify database joins, Extract, Transform, Load (ETL) processes to extract data and transform it into a common format or structure and load it into the aggregated dataset, data integration platforms to be used, data virtualization, etc. The aggregating of the data may be performed to not only generate the aggregated dataset but to ensure data quality and consistency by validating, cleansing and deduplicating the data.

In one or more embodiments, the data obtained from the at least one first external data source and the data obtained from the at least one second external data source may be in different formats, structures and/or conventions. As such, prior to aggregating the data, the server computer system 120 may engage a normalization engine to normalize the data obtained from the at least one first external data source and the data obtained from the at least one second external data source.

The normalization engine may be trained to normalize data ingested from each external data source. For example, during a training process, data ingested from each external data source may be reviewed to identify common data elements that represent the same or similar information. This may include field names, data types, structures, etc.

A unified data schema may be defined that accommodates all of the identified common data elements. The field names, data types, and relationships between them may be defined. The schema may be used as the blueprint for normalizing the data.

For each external data source, the data ingested therefrom may be mapped to the fields in the unified data schema. This may involve renaming fields, converting data types, or otherwise restructuring the data to fit the schema.

In one or more embodiments, the data ingested from one or more of the external data sources may include unique data elements or structures that may not align with the unified data schema. During the training process, the normalization engine may be trained to handle these variations by creating additional fields, transforming the data, or discarding non-essential information.

Training of the normalization engine may additionally include generating or defining data transformation logic. The data transformation logic may include processor-executable computer program code or scripts to transform the ingested data into a standardized format defined by the unified data schema. Programming languages such as for example Python™, JavaScript™, etc. may be used.

Through training of the normalization engine, data ingested from the various external data sources may be automatically normalized by the normalization engine and this may be done each time data is received or obtained.

As mentioned, in one or more embodiments, the data ingested from the at least one first external data source may include a first dataset that has one or more data points. The aggregated dataset may include one or more data points that align with the one or more data points of the first dataset.

In one or more embodiments where the aggregated dataset includes one or more data points that align with the one or more data points of the first dataset, the one or more data points of the first dataset may serve as a starting point for generating the one or more points of the aggregated dataset. For example, the one or more data points of the first dataset may be updated or otherwise manipulated to generate the one or more data points of the aggregated dataset.

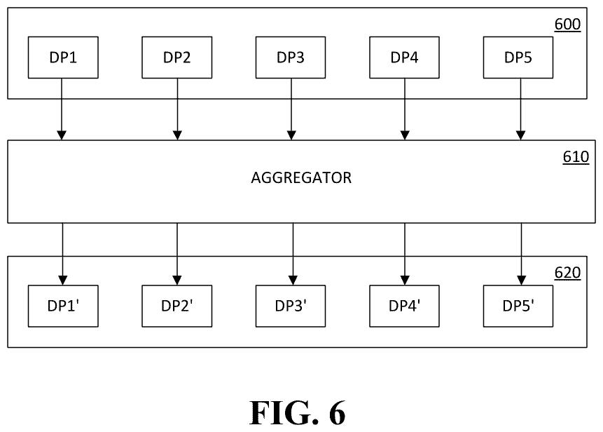

An example is shown in FIG. 6 which illustrates an example flowchart showing the generation of an aggregated dataset according to an embodiment. In this example, a first dataset 600 is obtained from the data ingested from at least one first external data source. The first dataset 600 includes data points DP1, DP2, DP3, DP4 and DP5. An aggregator 610 is provided that updates the data points DP1, DP2, DP3, DP4 and DP5 using data ingested from the at least one second external data source. The aggregator 610 generates an aggregated dataset 620 that includes data points DP1′, DP2′, DP3′, DP4′ and DP5′. As will be appreciated, in this example, the data points of the first dataset 600 serve as a starting point for generating the data points of the aggregated dataset 620.

To update the one or otherwise manipulate the one or more data points of the first dataset to generate the one or more data points of the aggregated dataset, at least some of the data ingested from the at least one second external data source may be used. For example, computer program code may be defined that maps one or more data points received from the at least one second external data source to one or more data points of the first dataset. The computer program code may include instructions that, when executed, update the one or more data points of the first dataset using one or more of the data points received from the at least one second external data source. In this manner, at least one data point of the aggregated dataset may be estimated based on data ingested from the at least one first external data source and the data ingested from the at least one second external data source.

In manners described herein, the data ingested from the at least one second external data source may be utilized to update the data ingested from the at least one first external data source and this may be done to ensure that the aggregated dataset includes fresh data that may be utilized in response to detection of the third trigger condition. For example, the data ingested from the at least one second external data source may include one or more updated data points that may be used to update the first dataset such that the data points of the aggregated dataset include fresh data. In this example, data is ingested from the at least one first external data source in response to the first trigger condition such as when network traffic drops below a first threshold. Data is ingested from the at least one second external data source in response to the second trigger condition such as when network traffic drops below a second threshold. As such, data required to generate the aggregated dataset may be obtained from different sources in response to different network conditions and this may be done to reduce the reliance on computing resources.

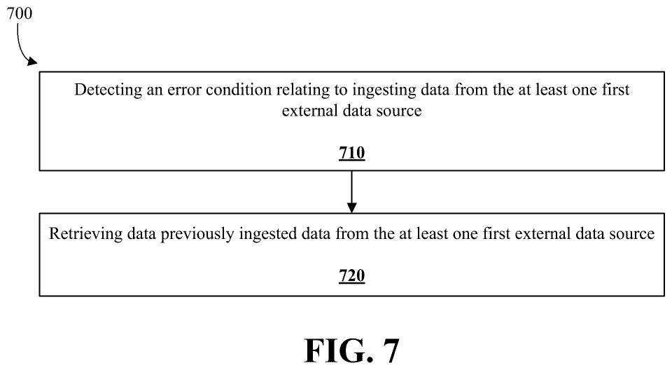

In one or more embodiments described herein, the server computer system 120 may not ingest data from the at least one first external data source and as such may perform operations to retrieve data previously ingested from the at least one first external data source. Reference is made to FIG. 7, which illustrates, in flowchart form, a method 700 for retrieving data previously ingested from the first data source. The method 700 may be implemented by a computing device having suitable processor-executable instructions for causing the computing device to carry out the described operations. The method 700 may be implemented, in whole or in part, by the server computer system 120. Of course, at least some of the operations may be performed or otherwise offloaded to the at least one external data source.

The method 700 includes detecting an error condition relating to ingesting data from the at least one first external data source (step 710).

The error condition may include determining that data has not been ingested from the at least one first external data source. The server computer system 120 may determine that data has not been ingested from the at least one first external source. For example, the server computer system 120 may expect data from the at least one first external source prior to a particular time. The particular time may be a time before data is to be ingested from the at least one second external data source (which may include the second predefined trigger time). The server computer system 120 may determine that the data has not been ingested from the at least one first external data source prior to the second predefined trigger time.

The error condition may include determining that the first trigger condition has not been satisfied prior to expiry of a particular time. For example, the server computer system 120 and/or the at least one first external data source may determine that the first trigger condition has not been satisfied prior to expiry of the particular time. The particular time may include a threshold amount of time or may include the second predefined trigger time. In this example, the server computer system 120 may determine that the network traffic has not dropped below the first threshold prior to the second predefined trigger time.

The method 700 includes, in response to detecting the error condition relating to ingesting data from the at least one first external data source, retrieving data previously ingested from the at least one first external data source (step 720).

The server computer system 120 may store data previously ingested from the at least one first external data source and may retrieve this data in response to detecting the error condition. For example, a previous first dataset may have been previously or recently ingested from the at least one first external data source and stored in memory. As such, in response to detecting the error condition, the server computer system 120 may retrieve the previous first dataset and this may be used to generate the aggregated dataset in accordance with steps 430 to 450 of the method 400 described herein. In this manner, the data ingested from the at least one second external data source may be used to update the previous first dataset such that the aggregated dataset may have fresh or up-to-date data in at least one or more of the data points.

It will be appreciated that operations similar to those defined in the method 700 described herein may be performed in response to detecting an error condition relating to ingesting data from the at least one second external data source.

In embodiments described herein, the data ingested from the at least one first external dataset, the data ingested from the at least one second external dataset, and the aggregated dataset may include a representation of one or more metrics. For example, the data ingested from the at least one first external dataset, the data ingested from the at least one second external dataset, and the aggregated dataset may represent one or more positions that may be utilized in response to detection of the third trigger condition described herein. The one or more positions may include, for example, transactions, holdings, net asset values, cash projections, etc. In this example, the data ingested from the at least one first external dataset may include end of day positions that include estimates for transactions, holdings, net asset values, cash projections, etc. The data ingested from the at least one second external dataset may include data used to update the at least one first external dataset prior to the start of a day. For example, the data ingested from the at least one second external dataset may include fixed income prices, capital stock prices, end of day prices, equity and securities corporate actions, etc. The aggregated dataset may include transactions, holdings, net asset values, cash projections that are derived from the data ingested from the at least one first external data source and the data ingested from the at least one second external data source and this may be done prior to the start of a day.

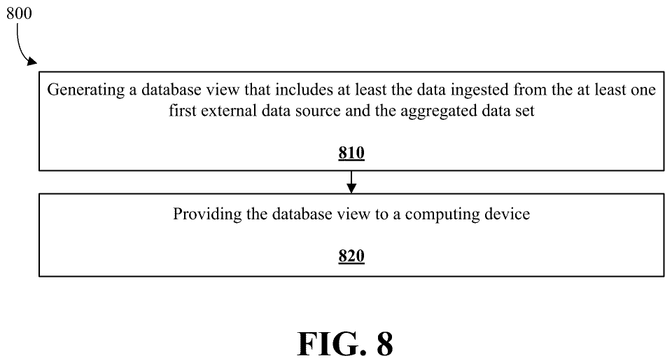

In one or more embodiments, once the aggregated dataset has been generated, operations may be performed to provide a database view of the aggregated dataset to a computing device. Reference is made to FIG. 8, which illustrates, in flowchart form, a method 800 for providing a database view of the aggregated dataset to a computing device. The method 800 may be implemented by a computing device having suitable processor-executable instructions for causing the computing device to carry out the described operations. The method 800 may be implemented, in whole or in part, by the server computer system 120.

The method 800 includes generating a database view that includes at least the data ingested from the at least one first external data source and the aggregated dataset (step 810).

In one or more embodiments, the database view may be generated to display data points of the first dataset ingested from the at least one first external data source and the aggregated dataset. In one example, the database view may display each data point of the first dataset adjacent to a corresponding data point of the aggregated dataset.

The method 800 includes providing the database view to the computing device (step 820).

The server computer system 120 may communicate with the computing device and may cause the computing device to display the database view on a display screen thereof. As mentioned, the database view may display each data point of the first dataset adjacent to a corresponding data point of the aggregated dataset. As such, a viewer may easily compare the data points of the first dataset with corresponding data points of the aggregated dataset.

It will be appreciated that one or more additional external data sources may provide data to be ingested by the server computer system 120 in manners similar to that described herein.

The methods described above may be modified and/or operations of such methods combined to provide other methods.

Furthermore, the description above generally describes operations that may be performed by a server and a client device in cooperation with one another. Operations that are described as being performed by the server may, instead, be performed by the client device.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

1. A computer system comprising:
at least one processor;
a communications module, coupled to the at least one processor, for communicating with one or more computer networks; and
a memory coupled to the at least one processor and storing instructions that, when executed by the at least one processor, cause the at least one processor to:
ingest data from at least one first external data source in response to a first trigger condition;
halt the ingesting of data from the at least one first external data source;
ingest data from at least one second external data source in response to a second trigger condition;
halt the ingesting of data from the at least one second external data source;
engage a normalization engine to automatically normalize the data ingested from the at least one first external data source and the at least one second external data source, the normalization engine including transformation logic comprising a schema mapping ruleset defining mappings between data elements for each of the at least the first external data source and the at least the second external data source to convert heterogeneous data formats into a standardized format; and
prior to satisfaction of a third trigger condition, aggregate the normalized data to generate an aggregated dataset.

2. The computer system of claim 1, wherein the first trigger condition includes at least one of:
determine that a current amount of network traffic drops below a first threshold;
determine that a current time is equal to a first predefined trigger time; or
determine that data from the at least one first external data source is available.

3. The computer system of claim 1, wherein the second trigger condition includes at least one of:
determine that the ingesting of the data from the at least one first external data source is complete;
determine that a current amount of network traffic drops below a second threshold;
determine that a current time is equal to a second predefined trigger time; or
determine that data from the at least one second external data source is available.

4. The computer system of claim 1, wherein when aggregating the data ingested from the at least one first external data source and the data ingested from the at least one second external data source to generate the dataset, the instructions, when executed by the at least one processor, further cause the at least one processor to:
estimate at least one data point of the aggregated dataset based on at least one of the data ingested from the at least one first external data source and the data ingested from the at least one second external data source.

5. The computer system of claim 1, wherein the at least one first external data source is different then the at least one second external data source.

6. The computer system of claim 1, wherein ingesting data from the at least one first external data source including batch processing data received from the at least one first external data source.

7. The computer system of claim 1, wherein ingesting data from the at least one second external data source includes batch processing data received from the at least one second external data source.

8. The computer system of claim 1, wherein the data ingested from the at least one first external data source includes a first dataset that has one or more data points that align with one or more data points of the aggregated dataset.

9. The computer system of claim 8, wherein the one or more data points of the first dataset serve as a starting point for the one or more data points of the aggregated dataset.

10. The computer system of claim 9, wherein when aggregating the data ingested from the at least one first external data source and the data ingested from the at least one second external data source to generate an aggregated dataset, the instructions, when executed by the at least one processor, further cause the at least one processor to:
update the one or more data points of the first dataset based on data ingested from the at least one second external data source to generate the one or more data points of the aggregated dataset.

11. A method comprising:
ingesting data from at least one first external data source in response to a first trigger condition;
halting the ingesting of data from the at least one first external data source;
ingesting data from at least one second external data source in response to a second trigger condition;
halting the ingesting of data from the at least one second external data source;
engage a normalization engine to automatically normalize the data ingested from the at least one first external data source and the at least one second external data source, the normalization engine including transformation logic comprising a schema mapping ruleset defining mappings between data elements for each of the at least the first external data source and the at least the second external data source to convert heterogeneous data formats into a standardized format; and
prior to satisfaction of a third trigger condition, aggregating the normalized data to generate an aggregated dataset.

12. The method of claim 11, wherein the first trigger condition includes at least one of:
determining that a current amount of network traffic drops below a first threshold;
determining that a current time is equal to a first predefined trigger time; or
determining that data from the at least one first external data source is available.

13. The method of claim 11, wherein the second trigger condition includes at least one of:
determining that the ingesting of the data from the at least one first external data source is complete;
determining that a current amount of network traffic drops below a second threshold;
determining that a current time is equal to a second predefined trigger time; or
determining that data from the at least one second external data source is available.

14. The method of claim 11, wherein aggregating the data ingested from the at least one first external data source and the data ingested from the at least one second external data source to generate the dataset includes:
estimating at least one data point of the aggregated dataset based on at least one of the data ingested from the at least one first external data source and the data ingested from the at least one second external data source.

15. The method of claim 11, wherein the first external data source is different then the second external data source.

16. The method of claim 11, wherein ingesting data from the at least one first external data source including batch processing data received from the at least one first external data source.

17. The method of claim 11, wherein ingesting data from the at least one second external data source includes batch processing data received from the at least one second external data source.

18. The method of claim 11, wherein the data ingested from the at least one first external data source includes a first dataset that has one or more data points that align with one or more data points of the aggregated dataset.

19. (canceled)

20. A non-transitory computer-readable storage medium storing instructions that, when executed by at least one processor of a computer system, cause the computer system to:
ingest data from at least one first external data source in response to a first trigger condition;
halt the ingesting of data from the at least one first external data source;
ingest data from at least one second external data source in response to a second trigger condition;
halt the ingesting of data from the at least one second external data source;
engage a normalization engine to automatically normalize the data ingested from the at least one first external data source and the at least one second external data source, the normalization engine including transformation logic comprising a schema mapping ruleset defining mappings between data elements for each of the at least the first external data source and the at least the second external data source to convert heterogeneous data formats into a standardized format; and
prior to satisfaction of a third trigger condition, aggregate the normalized data to generate an aggregated dataset.

21. The computer system of claim 1, wherein the at least one first external data source includes a machine learning module trained to predict when network traffic will likely drop below a first threshold.
